(19) United States
(12) Patent Application Publication
(10) Pub. No.: US 2016/0004204 A1
(43) Pub. Date: Jan. 7, 2016

(54) IMAGE FORMING APPARATUS AND METHOD

(71) Applicant: Samsung Electronics Co., Ltd., Suwon-si (KR)

(72) Inventors: Sang-bum Woo, Yongin-si (KR); Dong-guk Sim, Seoul (KR); Sung-dae Kim, Suwon-si (KR)

(73) Assignee: Samsung Electronics Co., Ltd., Suwon-si (KR)

(21) Appl. No.: 14/734,377

(22) Filed: Jun. 9, 2015

(30) Foreign Application Priority Data
Jul. 2, 2014 (KR) 10-2014-0082552

(51) Int. Cl. G03G 15/00

(52) U.S. Cl. CPC G03G 15/757

(57) ABSTRACT

Provided herein is an image forming apparatus and method, the apparatus including an engine configured to form a predetermined pattern having a predetermined multiple number length on a circumference length of each photosensitive drum in an image forming medium using the photosensitive drum, a motor configured to drive the photosensitive drum, and a motor controller configured to sense a cyclic velocity of the photosensitive drum using the formed predetermined pattern, and to control a phase and velocity of the motor using the sensed cyclic velocity.

### CROSS-REFERENCE TO RELATED APPLICATIONS

This application claims priority from Korean Patent Application No. 10-2014-0082552 filed in the Korean Intellectual Property Office on Jul. 2, 2014, the disclosure of which is incorporated herein by reference.

### BACKGROUND

1. Field

One or more embodiments relate to an image forming apparatus and method, and more particularly, to an image forming apparatus and method to sense a linear velocity of a photosensitive drum from which a linear velocity component of an intermediate transcription belt has been excluded so as to minimize color dislocation.

2. Description of the Related Art

Generally, an image forming apparatus that uses an electrophotography method such as a laser printer, copy machine, multifunction copy machine, and facsimile and the like has a laser scanning unit. The image forming apparatus uses a laser beam emitted from the laser scanning unit to form an electrostatic latent image on a surface of a photosensitive drum, and then transcripts/transfers the image onto a piece of paper to print a desired image.

Meanwhile, a electrophotography printing machine such as a color laser printer may be made up of four photosensitive drums Dy, Dc, Dm, and Dk prepared to respond to four corresponding colors of yellow (Y), cyan (C), magenta (M), and black (K), for example, a light exposure device configured to scan light to each of the photosensitive drums Dy, Dc, Dm, and Dk so as to form an electrostatic latent image of the desired image, a developing device configured to develop the electrostatic latent image by a developing solution for each of the aforementioned colors, and an image forming medium (or transcription/transfer belt, intermediate transcription/transfer belt) configured to receive each image developed on each photosensitive drum Dy, Dc, Dm, and Dk so that the images are superposed successively on the image forming medium to form an overlapped image including each of the colors and then to transcribe/transfer the same onto a piece of paper, for example.

Therefore, in order to print an image of the desired color, the electrophotography printing machine develops a respective image for each color on the four photosensitive drums Dy, Dc, Dm, and Dk, receives the respective image at an image position in a superposed manner, such as on the image forming medium, forms a final color image from the superposed respective images, and then prints the final color image on a piece of paper.

However, in order to form an exact desired color image, i.e., by superposing respective images of the four colors at the image position on such an image forming medium, the respective images of the four colors may need to be formed so as to be aligned with the exact same initial positions on each photosensitive drum Dy, Dc, Dm, and Dk and the exact same ending positions where the transcribing ends. That is because, even if all of the respective images are developed clearly on the four photosensitive drums Dy, Dc, Dm, and Dk, if any of the respective images of each photosensitive drum being transcribed to the image forming medium is slightly dislocated, the final color image obtained may not show the exact color and image.

Therefore, in order to realize an exact color image, it may be important to make a light exposure starting time for each photosensitive drum Dy, Dc, Dm, and Dk by the light exposure device exactly correspond to one another in consideration of an operating velocity of the image forming medium, and it may be important to adjust the light exposure starting time such that a plurality of colors that form one image are exactly superposed to one another, which is referred to as color registration.

However, a photosensitive drum has a cyclic velocity change. This is a phenomenon that naturally occurs in any rotating system unless it is an ideal and perfect rotating system. There are many reasons for such a phenomenon such as a photosensitive drum shape error (eccentricity, run-out etc.), Drum Alignment/installation, gear shape error, gear conveyance error, gear train structural incompleteness, coupling angular velocity transmission error and so forth. The velocity change of a drum that occurs due to the aforementioned errors becomes a direct reason for the color dislocation.

In this regard, conventionally, an encoder was installed in an axis of a gear that drives a photosensitive drum to sense an angular velocity so that a velocity that offsets the angular velocity may be input into a driving motor, or a pattern may be formed on the intermediate transcription belt and corresponding changes of position of a photosensitive drum cycle may be read so a component to a driving velocity of the motor may be added to offset the angular velocity that would cause the color dislocation.

Although the installed encoder approach has an advantage of identifying an angular velocity of the photosensitive drum in real time, and thus it takes no additional time to determine a control value of the driving motor, this encoder approach has disadvantages in that it requires additional cost to install the encoder, the gear axis needs to be extended in order to install the encoder, thereby increasing the size of the driver.

Furthermore, due to bending of the rotation axis of the photosensitive drum and changes in the center of rotation, color dislocation of the photosensitive drum cycle for a color image does not always correspond to the angular velocity of the photosensitive drum, and thus, when using the encoder approach, there is also a disadvantage that color dislocation of the photosensitive cycle may not be completely compensated.

Meanwhile, the pattern forming approach has an advantage in that the pattern forming approach provides more precision than the encoder approach, and in that the pattern forming approach may identify a home position of a gear using a photo sensor that is less expensive than the encoder.

However, the pattern forming approach has a disadvantage in that it takes additional time to form the pattern on the intermediate transcription belt and to read the changes of position of the photosensitive drum cycle, and further, when the driving roller component of the intermediate transcription belt is large, a control error may occur.

### SUMMARY

Therefore, an aspect of one or more embodiments of the present disclosure is a resolution of such aforementioned problems, that is, to provide an image forming apparatus capable of sensing a linear velocity of a photosensitive drum from which a linear velocity component of an intermediate transcription belt has been excluded so as to minimize a color dislocation, and an image forming method thereof.

One or more embodiments provide an image forming apparatus including an engine configured to form a predetermined pattern, having a predetermined length that is based on a multiple number of a circumference length of a photosensitive drum, on an image forming medium using the photosensitive drum, a motor configured to drive the photosensitive drum, and a motor controller configured to sense a cyclic velocity of the photosensitive drum using the formed predetermined pattern, and to control a phase and velocity of the motor using the sensed cyclic velocity.

The multiple number may be a minimum natural number that is greater than a diameter Di of a driving roller that drives the image forming medium divided by a subtraction of the diameter Di from a diameter Do of the photosensitive drum.

The multiple number may be 4.

The engine may include a plurality of photosensitive drums, and form respective predetermined patterns, each having a predetermined length that is based on a multiple number of a circumference length of a respective photosensitive drum, on the image forming medium.

The plurality of photosensitive drums may include a black (K) photosensitive drum, a cyan (C) photosensitive drum, a magenta (M) photosensitive drum, and a yellow (Y) photosensitive drum, the image forming apparatus may include a plurality of motors, and the plurality of motors may be a black (K) motor that drives the K photosensitive drum, a cyan (C) motor that drives the C photosensitive drum, a magenta (M) motor that drives the M photosensitive drum, and a yellow (Y) motor that drives the Y photosensitive drum.

The motor controller may sense a home position of each of the plurality of photosensitive drums, and determine a stop position of each of the plurality of photosensitive drums according to the sensed cyclic velocity and the sensed home position based on the respective predetermined patterns.

The respective predetermined patterns may each be patterns of a plurality of rod shapes, and the engine may form each of the respective predetermined patterns of each respective photosensitive drum on the image forming medium so that the respective predetermined patterns are interlaced on the image forming medium.

The engine may form each respective predetermined pattern on the image forming medium such that a main axis of each pattern of the plurality of rod shapes is arranged in a vertical or diagonal direction relative to a motion direction of the image forming medium.

The predetermined pattern may be a pattern of a plurality of rod shapes, and the engine may form the pattern of the plurality of rod shapes of the photosensitive drum on the image forming medium, and then form a pattern of a plurality of rod shapes of another photosensitive drum on the image forming medium.

The engine may form the pattern of the plurality of rod shapes of the photosensitive drum on the image forming medium such that a main axis of the pattern of the plurality of rod shapes of the photosensitive drum is arranged in a vertical or diagonal direction relative to a motion direction of the image forming medium.

The motor controller may sense the predetermined pattern formed on the image forming medium from each of a plurality of photosensitive drums, and identify respective gap changes for each of the plurality of photosensitive drums, and determine a respective velocity of a sine function format corresponding to the respective gap changes for each of the plurality of photosensitive drums, and the respective gap changes may represent differences between a designed gap between repeated shapes of the predetermined pattern and the identified respective gap changes between the repeated shapes of the predetermined pattern.

One or more embodiments provide an image forming method, the method including forming a predetermined pattern, having a predetermined length that is based on a multiple number of a circumference length of a photosensitive drum, on an image forming medium of an image forming apparatus using the photosensitive drum, sensing a cyclic velocity of the photosensitive drum using the formed predetermined pattern, and driving a motor of the image forming apparatus using the sensed cyclic velocity.

The multiple number may be a minimum natural number that is greater than a diameter Di of a driving roller that drives the image forming medium divided by a subtraction of the diameter Di from a diameter Do of the photosensitive drum.

The multiple number may be 4.

The image forming apparatus may include a plurality of photosensitive drums, and the forming of the predetermined pattern may include forming respective predetermined patterns, each having a predetermined length that is based on a multiple number of a circumference length of a respective photosensitive drum, on the image forming medium.

The method may further include synchronizing a velocity phase of each of a plurality of motors based on the sensed cyclic velocity, with the synchronizing including sensing a home position of each of the plurality of photosensitive drums, and determining a stop position of each of the plurality of photosensitive drums according to the sensed cyclic velocity and sensed home position.

The respective predetermined patterns may each be patterns of a plurality of rod shapes, and the forming of the predetermined pattern may include forming each of the respective predetermined patterns of each respective photosensitive drum on the image forming medium so that the respective predetermined patterns are interlaced on the image forming medium.

The forming of each of the respective predetermined patterns may include forming each of the patterns of the plurality of rod shapes on the image forming medium such that a main axis of each pattern of the plurality of rod shapes is arranged in a vertical or diagonal direction relative to a motion direction of the image forming medium.

The predetermined pattern may be a pattern of a plurality of rod shapes, and the forming of the predetermined pattern may include forming the pattern of the plurality of rod shapes of one photosensitive drum on the image forming medium, and then forming a pattern of a plurality of rod shapes of another photosensitive drum on the image forming medium.

The forming of the predetermined pattern may include forming the pattern of the plurality of rod shapes on the image forming medium such that a main axis of the pattern of the plurality of rod shapes is arranged in a vertical or diagonal direction relative to a motion direction of the image forming medium.

The sensing of the cyclic velocity may include sensing the predetermined pattern formed on the image forming medium from each of a plurality of photosensitive drums, identifying respective gap changes for each of the plurality of photosensitive drums, and determining a respective velocity of a sine function format corresponding to the respective gap changes for each of the plurality of photosensitive drums.

One or more embodiment may provide non-transitory computer readable medium including computer readable code to control at least one processing device to execute an image forming method, the method including forming a predetermined pattern, having a predetermined length that is a multiple number of a circumference length of the photosensitive drum, on an image forming medium of an image forming apparatus using the photosensitive drum, sensing a cyclic velocity of the photosensitive drum using the formed predetermined pattern, and driving a motor of the image forming apparatus using the sensed cyclic velocity.

Additional aspects and/or advantages will be set forth in part in the description which follows and, in part, will be apparent from the description, or may be learned by practice of the invention.

### BRIEF DESCRIPTION OF THE DRAWINGS

The above and/or other aspects of the present disclosure will be more apparent by describing certain present disclosure with reference to the accompanying drawings, in which:

FIG. 1 illustrates a configuration of an image forming apparatus according to one or more embodiments of the present disclosure;

FIG. 2 illustrates a configuration of a motor controller, such as the motor controller of FIG. 1, according to one or more embodiments of the present disclosure;

FIG. 3 illustrates a restricting of a position change that occurs due to a velocity change of a photosensitive drum in an image forming apparatus according to one or more embodiments of the present disclosure;

FIG. 4 illustrates a pattern for detecting a color dislocation according to one or more embodiments of the present disclosure;

FIG. 5 is a graph illustrating a gap difference of a pattern, such as the pattern of FIG. 4, according to one or more embodiments of the present disclosure;

FIGS. 6 and 7 are graphs illustrating a size and phase extracted from a signal, such as the signal of FIG. 5, according to one or more embodiments of the present disclosure;

FIGS. 8 and 9 illustrate a size and phase for a pattern for detecting a color dislocation in a case where the pattern is longer than a predetermined length, according to one or more embodiments of the present disclosure;

FIG. 10 illustrates a registration error for each color in a case where velocity control is not performed;

FIG. 11 illustrates a registration error for each color in a case where velocity control is performed according to one or more embodiments of the present disclosure;

FIG. 12 illustrates a pattern for detecting color dislocation according to one or more embodiments of the present disclosure;

FIG. 13 illustrates a pattern for detecting color dislocation according to one or more embodiments of the present disclosure;

FIG. 14 illustrates a pattern for detecting color dislocation according to one or more embodiments of the present disclosure;

FIGS. 15 and 16 illustrate a size error and phase error in a case where a pattern length is equal to or more than a predetermined length and where a pattern length is less than the predetermined length according to one or more embodiments of the present disclosure; and

FIG. 17 is a flowchart for an image forming method controlling a motor according to one or more embodiments of the present disclosure.

### DETAILED DESCRIPTION

Reference will now be made in detail to one or more embodiments, illustrated in the accompanying drawings, wherein like reference numerals refer to like elements throughout. In this regard, embodiments of the present invention may be embodied in many different forms and should not be construed as being limited to embodiments set forth herein. For example, matters defined in the present description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail. Accordingly, embodiments are merely described below, by referring to the figures, to explain aspects of the present invention.

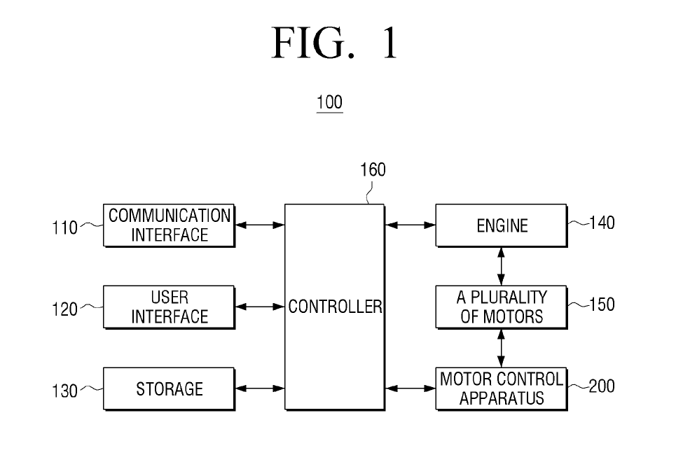

FIG. 1 illustrates a configuration of an image forming apparatus according to one or more embodiments of the present disclosure.

Referring to FIG. 1, an image forming apparatus 100 may be made up of a communication interface 110, user interface 120, storage 130, engine 140, a plurality of motors 150, controller 160 and motor controller 200, for example.

Herein, the image forming apparatus 100 is an apparatus configured to perform generating, printing, receiving, and transmitting of image data. The image forming apparatus 100 may be a printer, copy machine, facsimile, or a multifunction copy machine where functions of the printer, copy machine, and facsimile are combined.

Aspects of one or more embodiments of the present disclosure may be applied to an image forming apparatus configured to form an image, but such aspects may also be applied to an image reading apparatus such as a scanner.

The communication interface 110 is connected to a printing control terminal (not illustrated) such as a PC, laptop PC, PDA, and digital camera and so forth. Specifically, the communication interface 110 may be configured to connect the image forming apparatus 100 to an external apparatus, and may be configured in the format of being connected to a printing control terminal through a LAN (Local Area Network) and internet, but also in the format of being connected to the printing control terminal through a USB (Universal Serial Bus) port. Furthermore, it may be configured to be connected to the printing control terminal not only wired but also wirelessly.

Furthermore, the communication interface 110 receives printing data from the printing control terminal (not illustrated). Furthermore, in a case where the image forming apparatus 100 has a scanning function, the communication interface 110 may transmit scan data generated to the printing control terminal or to an external server (not illustrated). Furthermore, the communication interface 110 may receive a printing control command from the printing control terminal (not illustrated).

The user interface 120 is provided with a plurality of function keys through which a user may set or select various functions provided by the image forming apparatus 100, and the user interface 120 shows various information provided in the image forming apparatus. The user interface 120 may be configured as an apparatus that may realize both inputting and outputting such as a touch screen, or may be configured by a combination of an input such as a mouse (or keyboard, a plurality of buttons) and a display such as a monitor. The user may use a user interface window being provided through the user interface 120 to control a printing operation of the image forming apparatus 100.

Furthermore, the user interface 120 may display an operation state of the image forming apparatus 100. For example, in the case where the image forming apparatus is printing, the user interface 120 may display that the image forming apparatus is printing. Furthermore, in a case where an internal component such as a motor is broken, the user interface 120 may display that a breakdown has occurred.

The storage 130 stores print data. Specifically, the storage 130 stores print data received through the communication interface 110. Furthermore, the storage 130 may store a lookup table for controlling a motor 150. Herein, the lookup table may be a target driving velocity corresponding to a control command for the motor. Meanwhile, in an embodiment, the storage 130 stores the lookup table, but the lookup table may be stored by a motor controller 200 that will be explained hereinafter.

The storage 130 may store driving information of the motor 150. Specifically, the storage 130 may store driving information being received from the motor controller 200. Herein, the driving information may include information on a phase of the motor, information on a cyclic velocity of the motor, and information on a cyclic velocity difference from another motor and the like, for example.

Meanwhile, the storage 130 may be configured as a storage medium inside the image forming apparatus 100, or an external storage medium, for example, a removable disk such as a USB memory, or a web server connected to a network.

The engine 140 performs image forming. Specifically, the engine 140 may be made up of four photosensitive drums Dy, Dc, Dm, and Dk prepared to respond to four colors of yellow, cyan, magenta, and block, a light exposure device configured to scan light to each of the photosensitive drums Dy, Dc, Dm, and Dk and form an electrostatic latent image of a desired image, a developing device configured to develop an electrostatic latent image by a developing solution for each color, and an image forming medium (or transcription/transfer belt, intermediate transcription/transfer belt) configured to be transcribed/transferred with an image developed on each of the photosensitive drum Dy, Dc, Dm, and Dk in a superposed manner successively and to form an image of a complete color and to transfer it to a piece of paper.

For example, the engine 140 may be provided with a plurality of photosensitive drums, and five home position sensors configured to sense a home position of each of the plurality of photosensitive drums and an intermediate transcription belt. In this case, the engine 140 forms a pattern (P) for detecting color dislocation having a predetermined multiple number length (for example, four times the length) on a circumference length of the corresponding photosensitive drum through a corresponding laser scanner for each photosensitive drum, and scans a pattern (P) for detecting color dislocation formed on the corresponding photosensitive drum to the intermediate transcription belt.

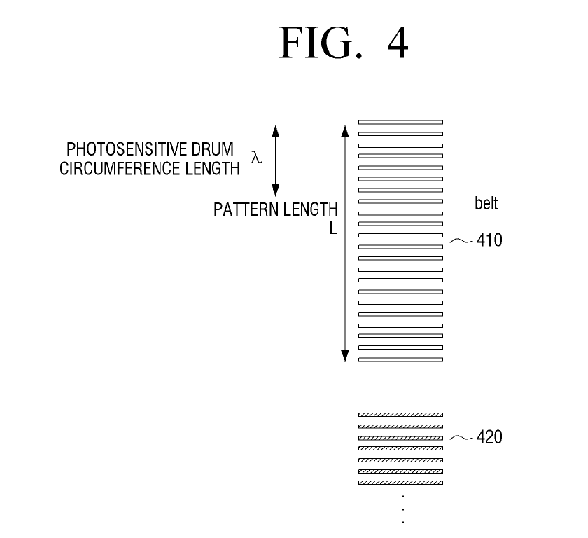

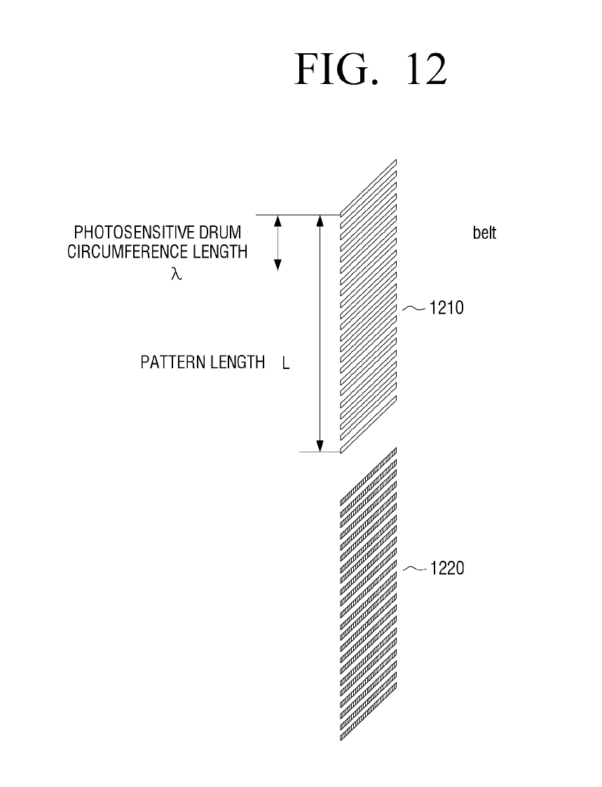

Such an operation by the engine 140 is performed through a control by a plurality of motors of the motor controller 200. Detailed explanation on forming a pattern will be explained hereinafter with reference to FIG. 4, and FIGS. 12 to 14.

Meanwhile, the home position sensor may be made up of a light sensor, and sense a position of a projection for detecting a home position at one side of a driving gear connected to each photosensitive drum and intermediate transcription belt, and sense a home position of each photosensitive drum and intermediate transcription belt.

Meanwhile, in an embodiment, it was explained that a plurality of photosensitive drums and an intermediate transcription belt in the engine 140 are driven separately, but depending on embodiments, the intermediate transcription belt may be driven by one photosensitive drum and one motor.

The plurality of motors 150 are direct current motors provided inside the image forming apparatus 100, and the plurality of motors 150 may be driven at a constant velocity or accelerated velocity depending on a size of current being input. Herein, each of the plurality of motors 150 may be a motor for driving a photosensitive drum, a fusing device, or various functions of the image forming apparatus such as moving paper. Herein, the motor for driving a photosensitive drum may include a black (K) motor for driving the black (K) photosensitive drum, a cyan (C) motor for driving the cyan (C) photosensitive drum, a magenta (M) motor for driving the magenta (M) photosensitive, and a yellow (Y) motor for driving the yellow (Y) photosensitive drum.

The motor controller 200 generates a driving signal (specifically, a driving voltage, for example) for a plurality of motors 150 according to a control command. Furthermore, the motor controller 200 uses a predetermined pattern formed in the image forming medium to sense a cyclic velocity of each photosensitive drum. Meanwhile, in an embodiment, it was explained that the motor controller 200 senses a cyclic velocity of each photosensitive drum, but sensing of the cyclic velocity of each photosensitive drum may be performed by a controller 160 that will be explained hereinafter.

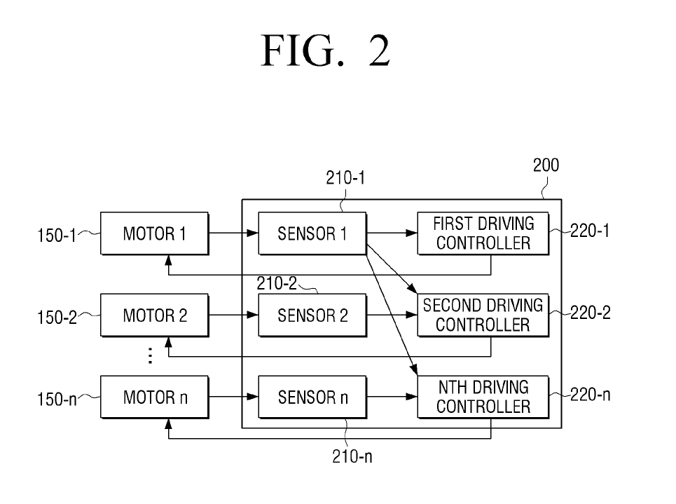

Furthermore, the motor controller 200 may control a phase and velocity of each of the plurality of motors that drive the photosensitive drum using the sensed cyclic velocity of the photosensitive drum. Detailed configuration and operation of the motor controller 200 will be explained hereinafter with reference to FIG. 2.

The controller 160 may control each component inside the image forming apparatus 100. Specifically, when the controller 160 receives printing data from the printing control terminal, the controller 160 controls an operation of the engine 140 so that the received printing data is printed, and transmits a control command for the plurality of motors that drive the engine 140 to the motor controller 200. For example, the controller 160 may transmit a control command for the plurality of motors such as a rotation start/stop, acceleration/moderation, velocity reference value command and the like to the motor controller 200. Meanwhile, in an embodiment, it was explained that the controller 160 transmits a control command for the plurality of motors, but the engine 140 may transmit the control command depending on embodiments.

As aforementioned, the image forming apparatus 100 according to one or more embodiments senses a linear velocity of a photosensitive drum from which a linear velocity component of an intermediate transcription belt has been excluded, and controls a motor using the sensed linear velocity of the photosensitive drum, and thus the image forming apparatus 100 may reduce a velocity difference between each of the photosensitive drums, thereby minimizing color dislocation.

Meanwhile, referring to FIG. 1, it was explained that the plurality of motors 150 and the motor controller 200 are separately configured, but the plurality of motors may be configured inside the motor controller 200. In such a case, the plurality of motors 150 may be configured separately from the image forming apparatus 100.

Meanwhile, referring to FIG. 1, it was explained that the image forming apparatus 100 is provided with a plurality of photosensitive drums, but as long as the image forming apparatus 100 has a photosensitive drum and an intermediate transcription belt, the number of photosensitive drums does not matter. That is, the present disclosure may also be applied to a case where there is only one photosensitive drum and one intermediate transcription belt.

FIG. 2 illustrates a configuration of a motor controller according to one or more embodiments of the present disclosure.

Referring to FIG. 2, the motor controller 200 may include a plurality of sensors 210 and a plurality of driving controllers 220. In an embodiment, the motor controller 200 may not have a motor 150, while in another embodiment the motor controller 200 may be configured to include the motor.

Each of the plurality of sensors 210, e.g., sensors 210-1 through 210-n, may sense a velocity of the motor 150. Specifically, the sensor 210 may sense a predetermined pattern formed in the image forming medium, confirm a gap change of a photosensitive drum, and compute a velocity in the form of a sine function that corresponds to the gap change. First of all, in order to sense the predetermined pattern formed in the image forming medium, the sensor 210 may be provided with a light source for emitting light, and a sensor configured to sense an intensity of a reflected light being reflected from a pattern or non-pattern area, in order to sense the pattern formed in the image forming medium. An operation of sensing the pattern, and computing a gap change and sine function velocity of the photosensitive drum will be explained hereinafter with reference to FIGS. 4 to 9. Herein, the image forming medium may be a transcription belt or an intermediate transcription belt, for example.

The number of driving controllers 220 may correspond to the number of motors that the motor controller 200 controls. Furthermore, each of the driving controllers 220 receives a control command from the controller 160, and controls a driving state of the motor 150 corresponding to the driving controller based on the received control command. Specifically, the driving controller 300 may receive a control command for the motor 150 from the controller 160. Herein, the control command may include a control command for a DC motor such as a rotation start/stop, acceleration/moderation, velocity reference value command and the like.

Meanwhile, such a control command may be received from the controller 160 through an SPI (Serial Peripheral Interface) that is an interface that allows data to be exchanged between two apparatuses in serial communication and a serial communication interface such as I²C that is a bilateral serial bus.

Furthermore, the driving controller 220 controls the motor 150 corresponding thereto depending on the received control command. Specifically, the driving controller 220 may generate a driving signal (specifically, PWM duty, for example) that corresponds to the control command. Meanwhile, the driving control hereinafter may differ depending on the motor to be controlled.

Specifically, of the plurality of driving controllers 220, the driving controller 220-1 for a K motor that drives a K photosensitive drum may drive a K motor 150-1 at a constant velocity in consideration of a linear velocity for the K motor.

Furthermore, of the plurality of driving controllers 220, the driving controller 220-2 for a C motor that drives a C photosensitive drum may drive a C motor 150-2 at a constant velocity in consideration of a linear velocity for the C motor.

Furthermore, of the plurality of driving controllers 220, the driving controller 220-3 for a M motor that drives a M photosensitive drum may drive a M motor 150-2 at a constant velocity in consideration of a linear velocity for the M motor.

Furthermore, of the plurality of driving controllers 220, the driving controller 220-3 for a Y motor that drives a Y photosensitive drum may drive a Y motor 150-2 at a constant velocity in consideration of a linear velocity for the Y motor.

Such a control operation for each photosensitive drum may be performed in units of one rotation cycle of the photosensitive drum, for example.

The motor controller 200 may sense a linear velocity of a photosensitive drum using a pattern having enough length to exclude a linear velocity component of an intermediate transcription belt, and thus may reduce a color difference between photosensitive drums, thereby minimizing color dislocation.

Meanwhile, in FIG. 2, it was explained that the motor controller 200 has a plurality of driving controllers, but the motor controller 200 may be configured to include a plurality of sensors and one driving controller for controlling a plurality motors, or the motor controller 200 may be configured to include a plurality of sensors and one driving controller for controlling a plurality of motors, or the motor controller 200 may be configured to include one sensor capable of sensing velocity of a plurality of motors and one driving controller for controlling a plurality of motors. Furthermore, one configuration may be embodied to sense a velocity and control a motor at the same time.

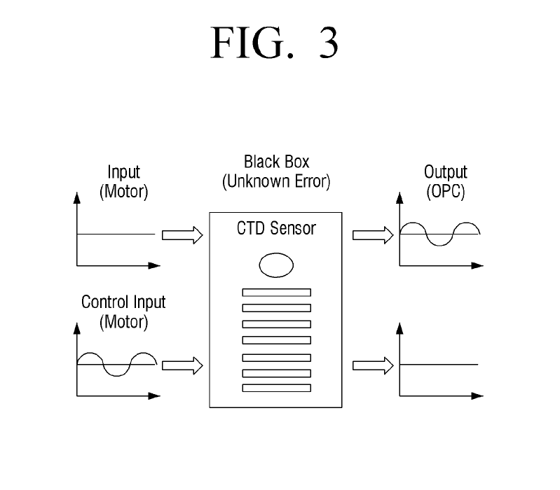

Hereinabove, the detailed configuration of the motor controller 200 was explained, but hereinafter, an operational aspect of one or more embodiments of the present disclosure will be explained with reference to FIGS. 3 to 5.

First of all, as mentioned above regarding conventional systems, a photosensitive drum has a cyclic velocity change. It can thus herein be recognized that such a velocity change of the photosensitive drum generates a gap change of a pattern (specifically, pattern for detecting color dislocation, for example) being transcribed to an image forming medium (transcription belt or intermediate transcription belt), and due to the characteristic of cyclic velocity change, the gap change has a sine curve format.

The velocity change of the photosensitive drum and gap change of a pattern for detecting color dislocation that occurs due to the velocity change may be represented by the below Equation 1, for example.

Gap change=A sin(ψt+θ) Equation 1:

Herein, A is a size of change (for example, 2Rop A_color π fo), ψ is an angular velocity(2πfo), fo is a velocity change frequency, θ is a phase, and Rop is a moderating ratio.

The aforementioned gap change is caused by a linear velocity change of the photosensitive drum, and thus the linear velocity of the photosensitive drum may be represented by the below Equation 2, for example.

A linear velocity of the photosensitive drum=Vm+A sin(ψt+θ) Equation 2:

Herein, Vm is a driving reference velocity of the photosensitive drum.

Therefore, since the size of change of the linear velocity of the photosensitive drum(Av) is ψA, the size of position change may be represented by the below Equation 3, for example.

A size of position change(A)=Av/ψ=Av/(2πf) Equation 3:

Referring to Equation 3, it can be seen that the gap change is proportionate to the size of velocity change, and is inversely proportionate to its change frequency. That is, the greater the velocity change of the photosensitive drum, or the smaller the frequency of its velocity change, the greater the gap change.

Therefore, it can be seen that in order to improve gap change, velocity change of the photosensitive drum can be alleviated. This will be explained in further detail with reference to FIG. 3.

FIG. 3 is a view for explaining a restricting of a position change that occurs due to a velocity change of a photosensitive drum in an image forming apparatus according to one or more embodiments of the present disclosure.

Referring to FIG. 3, even when a motor 150 provides a constant rotating force, an error mechanism occurs as it goes through various transmission processes, resulting in a defect of color dislocation. On the other hand, when one can know a relationship between a gap change of a pattern for detecting color dislocation with a velocity of the motor 150, it is possible to improve the gap change through an appropriate motor velocity variable control.

Therefore, when each photosensitive drum is velocity controlled such that it has no change in the linear velocity, theoretically, the color registration error will be 0.

However, in a general image color registration, a plurality of cyclic components of the photosensitive drum and driving roller components of the intermediate transcription belt occur initially together. That is, although the driving roller components of the intermediate transcription belt may be removed from an image by a position of each photosensitive drum, the plurality of photosensitive drum components have different sizes and phases, and thus have different transcription positions in the intermediate transcription belt, and thus may be removed by the position of the photosensitive drum.

Furthermore, in the case of controlling a velocity of the photosensitive driving motor in order to remove the photosensitive drum cyclic component from the color registration, a change of the cyclic component of the photosensitive drum must be extracted precisely. However, the change of the cyclic component of the photosensitive drum is determined by the size (A_color) of the cyclic component of the photosensitive drum for each color and the phase (Ph_color) of the cyclic component of the photosensitive drum.

Specifically, in order to remove the amount of dislocation between colors caused by the effect of the driving roller, generally, a pitch and the driving roller cycle between photosensitive drums are synchronized.

Meanwhile, a pitch between photosensitive drums is related to the size of an image forming apparatus, and due to the size limitations of an image forming apparatus, the driving roller of the intermediate transcription belt may be configured to be smaller than the photosensitive drums. Furthermore, in order to prevent a slip from occurring when driving the intermediate transcription belt, the driving roller of the intermediate transcription belt may be be bigger than a certain diameter.

Due to these reasons, the diameters of the photosensitive drums and the driving roller are similar, which makes the cycle that affects the image to be similar as well. The smaller the difference in cycle, the bigger the distortion becomes when extracting a component through sampling from the image. In an embodiment, color dislocation can be improved only when such distortion is prevented and when only the component of the photosensitive drum can be extracted and removed.

Therefore, in an embodiment, when forming a pattern for color registration, a pattern satisfying the below Equation 4, for example, may be used. That is, it is possible to form a pattern having a length L from which the linear velocity effect of the driving roller of the intermediate transcription belt can be excluded when sampling the pattern.

S·(M−1)≧K·λ Equation 4:

Herein, S is a center distance between patterns of a same color, M is a number of rod-shaped patterns of each color, λ is a rotation cycle of the photosensitive drum, K is a lowest natural number bigger than

$$\vert \frac{{D}_{i}}{{D}_{o} - {D}_{i}} \vert .$$

Furthermore, Di is a diameter of the driving roller that drives the intermediate transcription belt, and Do is a diameter of the photosensitive drum.

That is, by forming the driving roller that drives the image forming medium such that it has a diameter that is a multiple of a circumference length of a least natural number bigger than the diameter of the driving roller that drives the image forming medium divided by ‘the diameter of the photosensitive drum minus the diameter of the driving roller that drives the image forming medium’, it is possible to exclude the linear velocity component of the image forming medium (that is, intermediate transcription belt) when sensing the linear velocity of the photosensitive drum that will be explained hereinafter.

Meanwhile, it was explained in an embodiment that K is used by calculation based on the diameter of the driving roller of the intermediate transcription belt and the diameter of the photosensitive drum, but since the size of the driving roller of the intermediate transcription belt is usually bigger than that of the photosensitive drum, a constant number, 4, may be used as K.

FIG. 4 is a view illustrating a pattern for detecting color dislocation generated according to one or more embodiments of the present disclosure.

Referring to FIG. 4, a pattern (P) being transcribed to the intermediate transcription belt, e.g., pattern 410 or 420, in order to identify a gap change caused by a velocity change of the photosensitive drum may be made up of a pattern of a plurality of rods. Each rod-shaped pattern is designed to have a same thickness and same distance gap (Δ) there between. Meanwhile, each rod-shaped pattern may be formed at a rising edge or rolling edge point of a signal generated in the sensor.

Specifically, with the patterns designed to be distanced evenly, supposing an actual distance between n^{th} and n+1^{th} pattern of i^{th} color is Δ_in, and a reference distance is Δ_i, Xn is Δ_in −Δ_i. Herein, the size of the photosensitive drum of the ith color is

$$\vert \frac{2 {\sum }_{n = 1}^{M - 1} {X}_{n} {e}^{- j 2 π \frac{kn}{N}}}{M - 1} \vert ,$$

and its phase is

$$\frac{2 {\sum }_{n = 1}^{M - 1} {X}_{n} {e}^{- j 2 π \frac{kn}{N}}}{M - 1} .$$

Such a pattern has a length corresponding to a predetermined integer multiple (for example, 4) of the circumference length of the corresponding photosensitive drum. This is to obtain stable data and increase exactness of error fitting, and exclude the effect of linear velocity of the intermediate transcription belt. Then, each photosensitive drum is driven ‘a’ times in the order of YMCK.

For example, the engine 140 forms a black (K), magenta (M), cyan (C), and yellow (Y) pattern for each photosensitive drum so that they may be transcribed to the intermediate transcription belt. Herein, when the engine 140 transcribes a pattern for detecting each color dislocation repeatedly for more than once, a pattern (P) for detecting each color dislocation is formed in the photosensitive drum at a same time period with reference to a home position of the photosensitive drum.

Furthermore, the controller 160 identifies a gap change function by fitting with a sine function a gap change caused by a cyclic linear velocity change of each photosensitive drum, and uses this gap change function to find out each motor velocity function, thereby enabling restricting velocity change between photosensitive drums and significantly reducing color dislocation.

Hereinafter, for the sake of clarity, explanation will be made on one photosensitive drum 111 for identifying a gap change of a pattern for detecting color dislocation, identifying a motor velocity change for reducing a velocity change of a photosensitive drum based on that gap change, and verifying a velocity of a motor depending on this change of motor velocity.

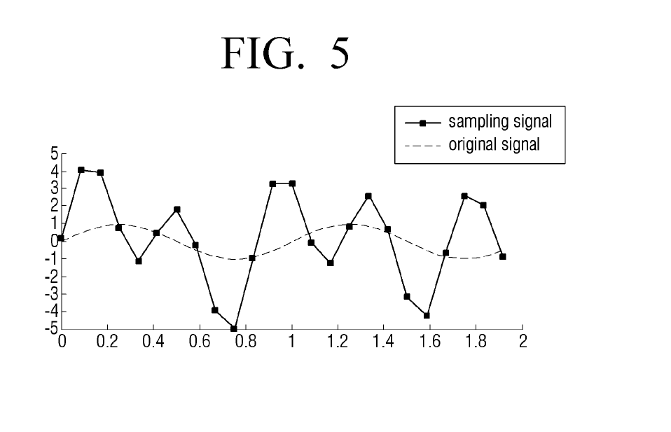

FIG. 5 is a graph illustrating a pattern distance difference of FIG. 4 according to one or more embodiments of the present disclosure.

As in FIG. 5, a gap difference is obtained by subtracting an original pattern distance from a sensed pattern distance.

A gap difference, i.e., a rod-shaped pattern distance, is fitted using a sine function (A sin(ψx/Vo+θ). It is possible to obtain an optimal fitting by squaring a gap difference (Δd) and a A sin(ψx/Vo+θ) difference calculated from each sensed data, summing these differences, and then finding A and θ that minimizes that sum of squared errors from a range of 0≦A≦[(Max(Δd)−Min(Δd))/2] and 0≦θ≦2π.

Only when a difference between a maximum value and a minimum value of the four Os obtained from the above fitting process is less than 90°, an average of θs is calculated, and then two maximum values of the four As are selected and then their average is calculated. The result is the final size and phase of the gap change function.

Next, since the gap change is identified, in order to alleviate this gap change, it may be necessary to find out the relationship between motor velocity and this gap change. The gap change obtained from a pattern (P) for detecting color dislocation shows a cyclic change format, and thus may be expressed in a sine function of A sin(ψ+θ).

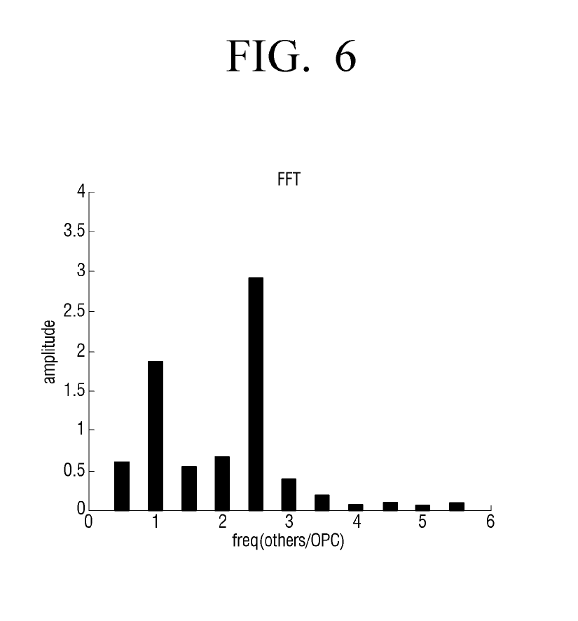

Meanwhile, in the case where such sensing of linear velocity of the motor is performed through a pattern that does not have a sufficient length, the calculated linear velocity includes not only the linear velocity of the photosensitive drum but also the linear velocity of the intermediate transcription belt. This will be explained with reference to FIGS. 5 and 6.

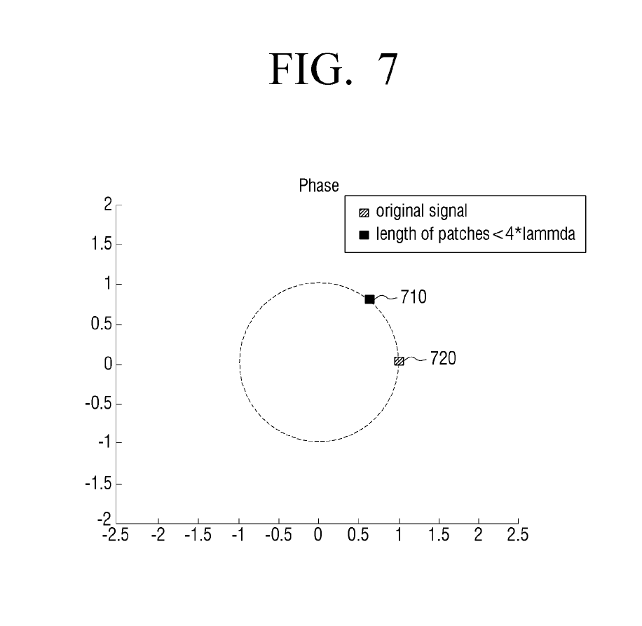

FIGS. 6 and 7 are views illustrating a size and phase extracted from a signal, such as the signal of FIG. 5, according to one or more embodiments of the present disclosure.

Referring to FIGS. 6 and 7, the actual amplitude of the photosensitive is 1, but the measured amplitude is 1.9, which means that there is a difference. Furthermore, as for the phase, the actual photosensitive drum component shows 0° but the measured value is 51°, which means that there is also a difference. Such an error does not decrease even by measuring repeatedly.

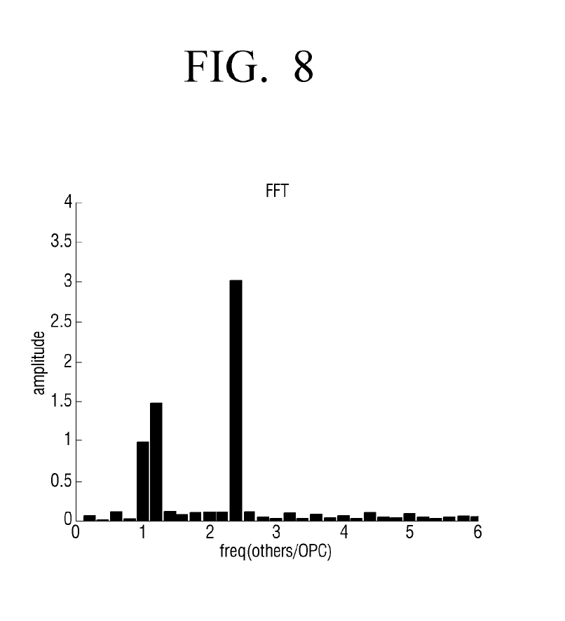

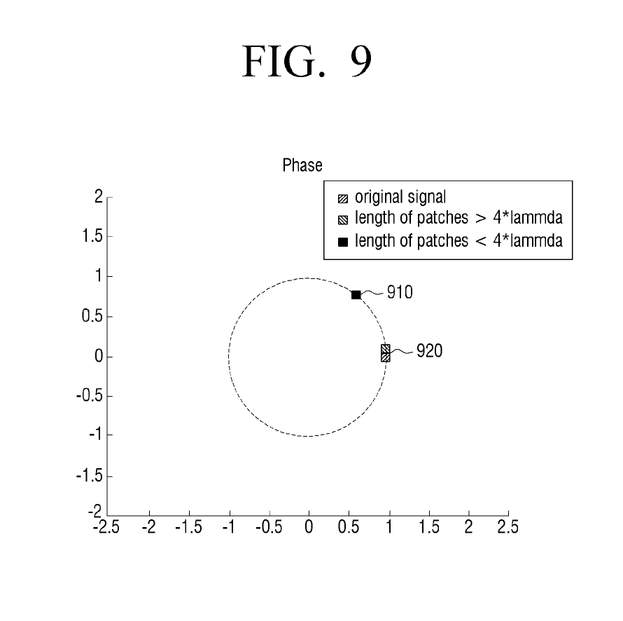

However, it is possible to reduce the amplitude and phase error by forming the pattern for detecting color dislocation in a predetermined multiple number on the circumference length of the photosensitive drum. This will be explained in further detail with reference to FIGS. 8 and 9 hereinafter.

FIGS. 8 and 9 are views illustrating a size and phase of a pattern for detecting color dislocation when the pattern is longer than a predetermined length according to one or more embodiments of the present disclosure.

Referring to FIG. 8, in the case where the pattern is four times the circumference length of the photosensitive drum (that is, when the pattern has a length satisfying Equation 4), the cycle of the photosensitive drum and the driving roller cycle of the intermediate transcription belt are separated, and thus the amplitude is extracted exactly. Furthermore, referring to FIG. 9, in can be seen that in the case where the length of the pattern is four times the circumference length of the photosensitive drum, the phase also has a smaller error, unlike in FIG. 7.

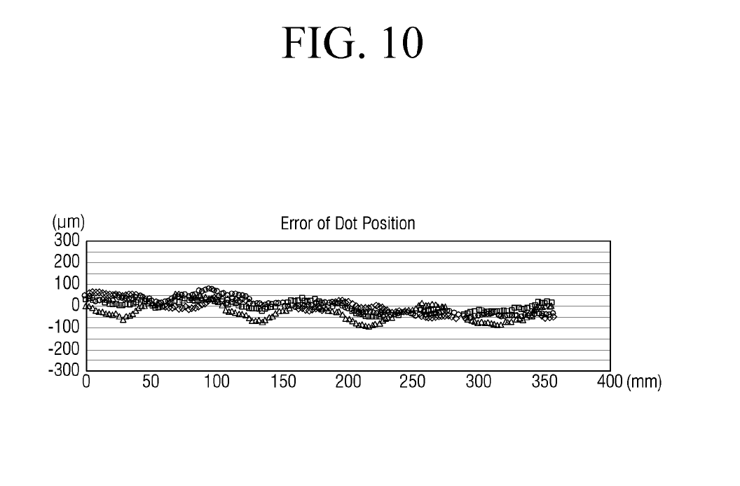

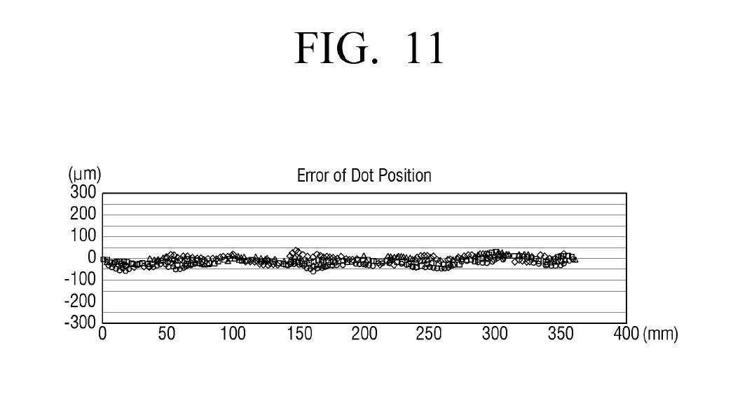

FIG. 10 is a view illustrating registration errors per color when a velocity control is not performed, FIG. 11 is a view illustrating registration errors when a velocity control is performed according to one or more embodiments of the present disclosure.

Referring to FIGS. 10 and 11, it can be seen that when a velocity control is not performed, a registration error difference per color is 100 μm or more, but when an image forming method of the present disclosure is performed, the registration error difference between colors may be reduced.

FIG. 12 is a view illustrating a pattern for detecting color dislocation generated according to one or more embodiments of the present disclosure.

Referring to FIG. 12, a pattern (P) being transcribed to the intermediate transcription belt to identify a gap change caused by a velocity change in the photosensitive drum is a pattern of a plurality of rods. Furthermore, each rod of the pattern is arranged diagonally to the motion direction of the image forming apparatus. That is, what is different between the pattern P of FIG. 12 and the pattern of FIG. 4, for example, is that the rod-shaped pattern is arranged diagonally to the motion direction of the intermediate transcription belt, e.g., not vertically.

In this regard, here, the size and phase of the photosensitive drum according to one or more embodiments may be the same as described above, depending on embodiment.

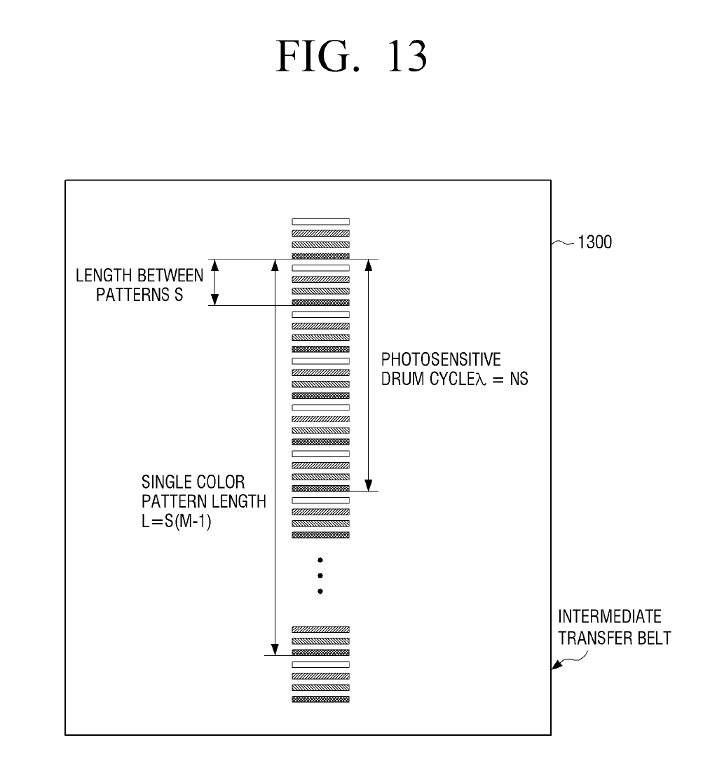

FIG. 13 is a view illustrating a pattern for detecting color dislocation according to one or more embodiments of the present disclosure.

Referring to FIG. 13, a predetermined pattern made up of a pattern of a plurality of rods, and the rod pattern of each of the plurality of photosensitive drums is arranged alternately to one another, e.g., so that a pattern of a plurality of rods shapes for one color may be interlaced on the intermediate transcription belt with a pattern of a plurality of rods for another color. That is, it is possible to use a method of reducing the total pattern length by forming a neighboring pattern in another color.

That is, in order to increase the precision of an extracted photosensitive component, when the total length of a single color S(M−1) is equal to or more than 4λ, it is possible to have a wide distance between patterns. Herein, it is possible to insert a second color pattern between a same color neighboring pattern, and reduce the total pattern length. A size and phase of the photosensitive drum may be obtained from a signal read from the pattern in a same manner as described above, depending on embodiment.

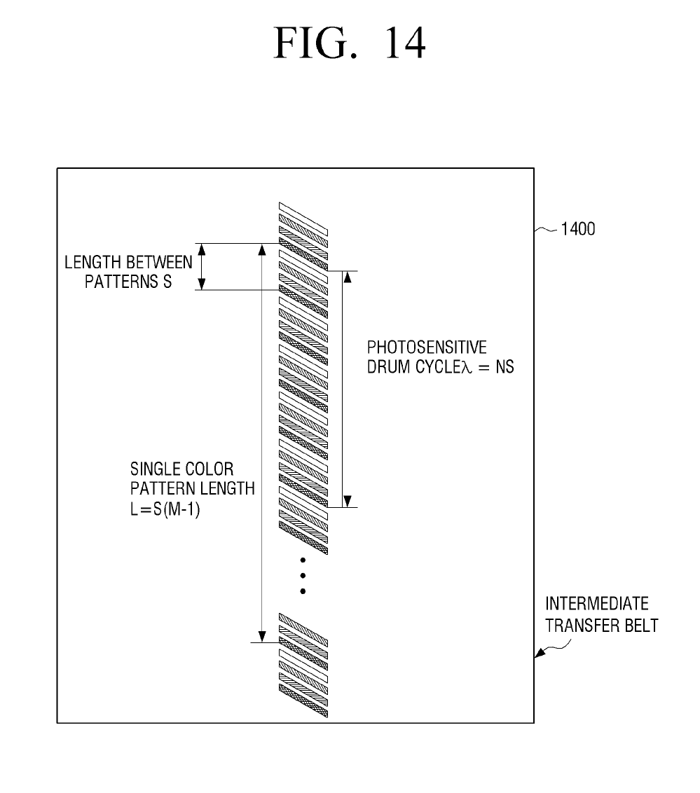

FIG. 14 is a view illustrating a pattern for detecting color dislocation generated according to one or more embodiments of the present disclosure.

Referring to FIG. 14, a predetermined pattern is made up of a pattern of a plurality of rods, and each rod-shaped pattern of the plurality of photosensitive drums is arranged alternately to one another. Furthermore, each rod shape is arranged diagonally to the motion direction of the intermediate transcription belt. That is, it is possible to use a method of reducing the total pattern length by forming a neighboring pattern in another color.

That is, in order to increase the precision of an extracted photosensitive component, when the total length L of a single color S(M−1) is equal to or more than 4λ, it is possible to have a wide distance between patterns. Herein, it is possible to insert a second color pattern between a same color neighboring pattern, and reduce the overall total pattern length. A size and phase of the photosensitive drum may be obtained from a signal read from the pattern in a same manner as described above, depending on embodiment.

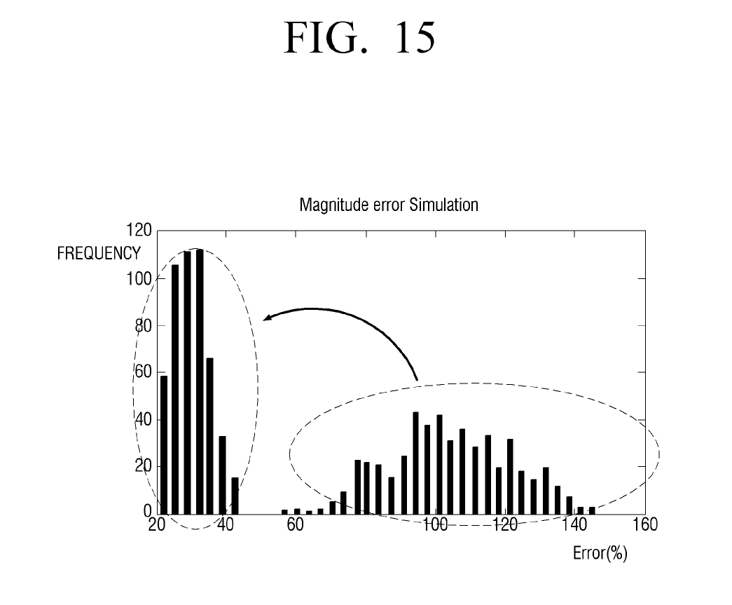

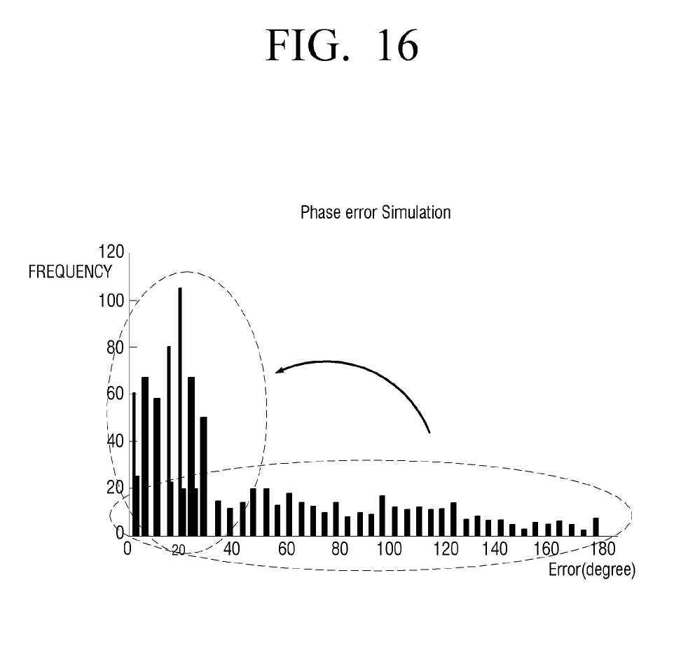

FIGS. 15 and 16 are views illustrating a size error and phase error in the case where a pattern length is equal to or more than a predetermined length and less than the predetermined length, according to one or more embodiments of the present disclosure.

Referring to FIG. 15, even if there is a component of a driving roller of a photosensitive drum and intermediate transcription belt in a color registration error component initially, it is possible to exactly measure the component of the photosensitive of a single color and remove the same. Referring to FIG. 15, it can be seen that when the pattern length is equal to or more than a predetermined multiple times, an error rate for an amplitude is significantly reduced.

Referring to FIG. 16, it can be seen that when the pattern length is equal to or more than a predetermined multiple, an error rate for a phase is significantly reduced.

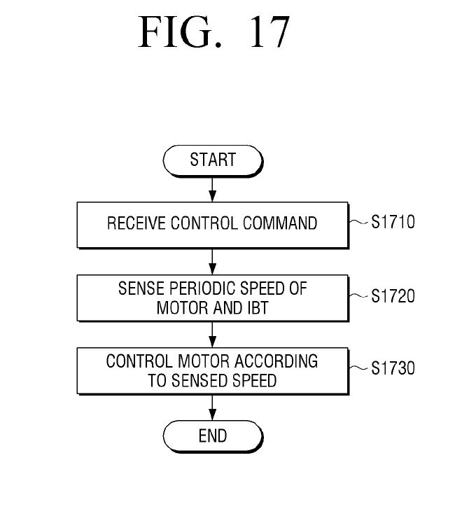

FIG. 17 is a flowchart for an image forming method controlling a motor according to one or more embodiments of the present disclosure.

Referring to FIG. 17, first of all, a control command for a plurality of photosensitive media is received (S1710). Herein, the control command may include a control command for rotation start/stop, acceleration/moderation, velocity instruction value etc. for the plurality of motors.

A cyclic velocity of each of the plurality of motors that drive each of a plurality of photosensitive media is sensed (S1720). Specifically, a predetermined pattern having a length of a predetermined multiple number is formed on a circumference length of the photosensitive drum in the intermediate transcription belt, the formed pattern is sensed, a gap change of each of the plurality of photosensitive drum is identified, and then a velocity of a sine function format that corresponds to the identified gap change may be computed.

Then, the plurality of motors are driven according to the sensed cyclic velocity (S1730). Specifically, based on the velocity (that is, linear velocity) of a sine function format sensed for each motor, the plurality of motors may be driven so that the computed linear velocity is offset.

The image forming method may sense the linear velocity of the photosensitive drum from which the linear velocity component of the intermediate transcription belt is excluded, control the motor using the sensed linear velocity of the photosensitive drum, and thus may reduce the velocity difference the photosensitive drums, thereby minimizing color dislocation. As only an example, the image forming method illustrated in FIG. 17 may be executed on a motor controller having the configuration of FIG. 2 and/or the image forming apparatus 100 having the configuration of FIG. 1, or on an image forming apparatus or motor controller having other types of configuration.

Depending on embodiment, apparatuses, systems, and units descriptions herein may respectively include one or more hardware devices or hardware processing elements. For example, in one or more embodiments, any described apparatus, system, and unit may further include one or more desirable memories, and any desired hardware input/output transmission devices.

In addition to the above described embodiments, embodiments can also be implemented by at least one processing device, such as a processor or computer. Further to the above described embodiments, embodiments can also be implemented through computer readable code/instructions in/on a non-transitory medium, e.g., a computer readable medium, to control at least one processing device, such as a processor or computer, to implement any above described embodiment. The medium can correspond to any defined, measurable, and tangible structure permitting the storing and/or transmission of the computer readable code.

The media may also include, e.g., in combination with the computer readable code, data files, data structures, and the like. One or more embodiments of computer-readable media include: magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Computer readable code may include both machine code, such as produced by a compiler, and files containing higher level code that may be executed by the computer using an interpreter, for example. The media may also be any defined, measurable, and tangible distributed network, so that the computer readable code is stored and executed in a distributed fashion. Still further, as only an example, the processing element could include a processor or a computer processor, and processing elements may be distributed and/or included in a single device. The processing element may be a specially designed computing device to implement one or more of the embodiments described herein.

The computer-readable media may also be embodied in at least one application specific integrated circuit (ASIC) or Field Programmable Gate Array (FPGA), as only examples, which execute (processes like a processor) program instructions.

While aspects of the present invention has been particularly shown and described with reference to differing embodiments thereof, it should be understood that these embodiments should be considered in a descriptive sense only and not for purposes of limitation. Descriptions of features or aspects within each embodiment should typically be considered as available for other similar features or aspects in the remaining embodiments. Suitable results may equally be achieved if the described techniques are performed in a different order and/or if components in a described system, architecture, device, or circuit are combined in a different manner and/or replaced or supplemented by other components or their equivalents.

Although a few embodiments of the present disclosure have been shown and described, with additional or alternative embodiments being equally available, it would be appreciated by those skilled in the art that changes may be made in these embodiments without departing from the principles and spirit of the invention, the scope of which is defined in the claims and their equivalents.

What is claimed is:

1. An image forming apparatus comprising:
an engine configured to form a predetermined pattern, having a predetermined length that is based on a multiple number of a circumference length of a photosensitive drum, on an image forming medium using the photosensitive drum;
a motor configured to drive the photosensitive drum; and
a motor controller configured to sense a cyclic velocity of the photosensitive drum using the formed predetermined pattern, and to control a phase and velocity of the motor using the sensed cyclic velocity.

2. The apparatus according to claim 1,
wherein the multiple number is a minimum natural number that is greater than a diameter Di of a driving roller that drives the image forming medium divided by a subtraction of the diameter Di from a diameter Do of the photosensitive drum.

3. The apparatus according to claim 1,
wherein the multiple number is 4.

4. The apparatus according to claim 1,
wherein the engine comprises a plurality of photosensitive drums, and forms respective predetermined patterns, each having a predetermined length that is based on a multiple number of a circumference length of a respective photosensitive drum, on the image forming medium.

5. The apparatus according to claim 4,
wherein the plurality of photosensitive drums include a black (K) photosensitive drum, a cyan (C) photosensitive drum, a magenta (M) photosensitive drum, and a yellow (Y) photosensitive drum,
the image forming apparatus comprises a plurality of motors, and
the plurality of motors are a black (K) motor that drives the K photosensitive drum, a cyan (C) motor that drives the C photosensitive drum, a magenta (M) motor that drives the M photosensitive drum, and a yellow (Y) motor that drives the Y photosensitive drum.

6. The apparatus according to claim 4,
wherein the motor controller senses a home position of each of the plurality of photosensitive drums, and determines a stop position of each of the plurality of photosensitive drums according to the sensed cyclic velocity and the sensed home position based on the respective predetermined patterns.

7. The apparatus according to claim 4,
wherein the predetermined pattern is a pattern of a plurality of rod shapes, and
the engine forms the pattern of the plurality of rod shapes of the photosensitive drum on the image forming medium, and then forms a pattern of a plurality of rod shapes of another photosensitive drum on the image forming medium.

8. The apparatus according to claim 4,
wherein the respective predetermined patterns are each patterns of a plurality of rod shapes, and
the engine forms each of the respective predetermined patterns of each respective photosensitive drum on the image forming medium so that the respective predetermined patterns are interlaced on the image forming medium.

9. The apparatus according to claim 7,
wherein the engine forms each respective predetermined pattern on the image forming medium such that a main axis of each pattern of the plurality of rod shapes is arranged in a vertical or diagonal direction relative to a motion direction of the image forming medium.

10. The apparatus according to claim 1,
wherein the motor controller senses the predetermined pattern formed on the image forming medium from each of a plurality of photosensitive drums, and identifies respective gap changes for each of the plurality of photosensitive drums, and determine a respective velocity of a sine function format corresponding to the respective gap changes for each of the plurality of photosensitive drums, and
wherein the respective gap changes represent differences between a designed gap between repeated shapes of the predetermined pattern and the identified respective gap changes between the repeated shapes of the predetermined pattern.

11. An image forming method, the method comprising:
forming a predetermined pattern, having a predetermined length that is based on a multiple number of a circumference length of a photosensitive drum, on an image forming medium of an image forming apparatus using the photosensitive drum;
sensing a cyclic velocity of the photosensitive drum using the formed predetermined pattern; and
driving a motor of the image forming apparatus using the sensed cyclic velocity.

12. The method according to claim 11,
wherein the multiple number is a minimum natural number that is greater than a diameter Di of a driving roller that drives the image forming medium divided by a subtraction of the diameter Di from a diameter Do of the photosensitive drum.

13. The method according to claim 11,
wherein the multiple number is 4.

14. The method according to claim 11,
wherein the image forming apparatus comprises a plurality of photosensitive drums, and
the forming of the predetermined pattern includes forming respective predetermined patterns, each having a predetermined length that is based on a multiple number of a circumference length of a respective photosensitive drum, on the image forming medium.

15. The method according to claim 14,
further comprising synchronizing a velocity phase of each of a plurality of motors based on the sensed cyclic velocity, and
the synchronizing including sensing a home position of each of the plurality of photosensitive drums, and determining a stop position of each of the plurality of photosensitive drums according to the sensed cyclic velocity and sensed home position.

16. The method according to claim 14,
wherein the predetermined pattern is a pattern of a plurality of rod shapes, and
the forming of the predetermined pattern includes forming the pattern of the plurality of rod shapes of one photosensitive drum on the image forming medium, and then forming a pattern of a plurality of rod shapes of another photosensitive drum on the image forming medium.

17. The method according to claim 14,
wherein the respective predetermined patterns are each patterns of a plurality of rod shapes, and
the forming of the predetermined pattern includes forming each of the respective predetermined patterns of each respective photosensitive drum on the image forming medium so that the respective predetermined patterns are interlaced on the image forming medium.

18. The method according to claim 16,
wherein the forming of each of the respective predetermined patterns includes forming each of the patterns of the plurality of rod shapes on the image forming medium such that a main axis of each pattern of the plurality of rod shapes is arranged in a vertical or diagonal direction relative to a motion direction of the image forming medium.

19. The method according to claim 11,
wherein the sensing of the cyclic velocity includes sensing the predetermined pattern formed on the image forming medium from each of a plurality of photosensitive drums, identifying respective gap changes for each of the plurality of photosensitive drums, and determining a respective velocity of a sine function format corresponding to the respective gap changes for each of the plurality of photosensitive drums.

20. A non-transitory computer readable medium including computer readable code to control at least one processing device to execute an image forming method, the method comprising:
forming a predetermined pattern, having a predetermined length that is a multiple number of a circumference length of the photosensitive drum, on an image forming medium of an image forming apparatus using the photosensitive drum;
sensing a cyclic velocity of the photosensitive drum using the formed predetermined pattern; and
driving a motor of the image forming apparatus using the sensed cyclic velocity.
